(19) United States
(12) Patent Application Publication
(10) Pub. No.: US 2013/0011520 A1
(43) Pub. Date: Jan. 10, 2013

(54) NECTAR OF MALT SODA, AS WELL AS METHOD AND DEVICE OF PREPARING THE SAME

(76) Inventor: Chunming WANG, Chengdu (CN)

(21) Appl. No.: 13/617,731

(22) Filed: Sep. 14, 2012

Related U.S. Application Data
(63) Continuation of application No. PCT/CN2011/082017, filed on Nov. 10, 2011.

(30) Foreign Application Priority Data
Dec. 28, 2010 (CN) 201010608992.8

(51) Int. Cl. A23L 2/38; A23L 2/60; A23L 2/42; A23L 2/54; B01F 13/10; A23L 2/52; A23L 2/74

(52) U.S. Cl. 426/72; 426/590; 426/548; 426/489; 426/311; 426/477; 99/323.2

(57) ABSTRACT

The invention relates to the field of food, in particular to nectar of malt soda and method and devices for preparation of the same. The nectar of malt soda comprises malt juice and soda water. The preparation method includes: preparing malt juice; preparing soda water; mixing and formulating the malt juice and the soda water; sterilizing and filtrating the mixed and formulated mixture of the malt juice and the soda water; packaging the sterilized and filtrated mixture solution of the malt juice and the soda water. The devices for preparation include: malt juice preparation device; soda water preparation device; mixing and formulating device; sterilizing and filtrating device; packaging device. The nectar of malt soda and preparation method and device of the invention can be used to prepare liquid malt beverage.

### TECHNICAL FIELD

The invention relates to a field of beverage, particularly to a nectar of malt soda, as well as method and device of preparing the same.

### Description of the Related Art

With the economic development and people's rising living standards, the requirements for beverages is not limited to quench their thirst, more focus on taste, nutrition, health and other functions. As a result various beverages emerge endlessly. Production of beverages with raw materials such as malt, bamboo leaves, baking soda (sodium bicarbonate) and the like becomes possible today, and is welcomed by consumers for its health care function.

Malt has functions of promoting the circulation of qi, helping digestion, tonifying spleen and promoting appetite, and is a highly nutritious substance. Therefore, malt gradually becomes the focus of raw material for developing new drinks. However, according to the prior art, it is not easy to produce liquid beverage with malt juice. In addition, malt beverage still remains at the level of solid beverage since processes, formulas, taste, health effects, industrial production and so on are relatively backward. Faced with a number of liquid drinks, solid malt beverages with higher nutritional value, but almost can not find its market since it is difficult to meet the user demand for liquid drinks.

### SUMMARY OF THE INVENTION

The invention provides a nectar of malt soda, as well as method and device for preparing the same, which can prepare liquid malt beverage.

The invention provides a nectar of malt soda, comprising malt juice and soda water.

Preferably, the nectar of malt soda further comprises: vitamin C, and/or calcium chloride, and/or aspartame, and/or erythritol.

The invention further provides a method for preparing the nectar of malt soda, including
preparing malt juice;
preparing soda water;
mixing and formulating the malt juice and the soda water;
sterilizing and filtrating the mixed and formulated mixture solution of the malt juice and the soda water;
packaging the sterilized and filtrated mixture solution of the malt juice and the soda water.

Preferably, the preparation of malt juice includes:
Smashing the malt;
Squeezing the smashed malt;
cooking the squeezed malt; and
filtrating the cooked malt for one or more times.

Preferably, the cooking the squeezed malt includes: the mass ratio of malt to water is 1:9;
and/or
a temperature for the cooking is from 96° C. to 98° C. in the cooking the squeezed malt; and/or
the cooking the squeezed malt includes stirring the malt during the cooking;
and/or
time for the cooking is from 15 minutes to 18 minutes in the cooking the squeezed malt.

Preferably, the preparation of soda water includes:
filtrating raw water for one or more times;
adding sodium bicarbonate to the filtrated raw water;
sterilizing the raw water added sodium bicarbonate.

Preferably, the adding sodium bicarbonate to the filtrated raw water includes: adding 0.8 mg to 1 mg of sodium bicarbonate to each 1 L water.

Preferably, the mixing and formulating the malt juice and the soda water includes:
mixing and stirring 60%-65% of soda water and 35%-40% malt juice.

Preferably, the mixing and formulating the malt juice and the soda water further includes:
adding additives to the homogeneous mixture solution of soda water and malt juice after stirred, the additives including vitamin C, and/or calcium chloride, and/or aspartame, and/or erythritol.

Preferably, the mixture solution of soda water and malt juice further includes: vitamin C, and/or calcium chloride, and/or aspartame, and/or erythritol.

Preferably, amounts of the additives are: in case of 1000 kg of soda water and malt juice mixture solution, the additives include 0.5 kg to 0.6 kg vitamin C, and/or 0.05 kg to 0.08 kg calcium chloride, and/or 0.02 kg to 0.03 kg aspartame, and/or 10 kg to 12 kg erythritol.

Preferably, after sterilizing and filtrating the mixed and formulated mixture solution of the malt juice and the soda water, and before packaging the sterilized and filtrated mixture solution of malt juice and soda water, the method further includes:
pressing carbon dioxide to the sterilized and filtrated mixture solution, wherein the pressure on the sterilized and filtrated mixture solution is 3.8 MPa to 4 MPa, flow rate of the carbon dioxide is 5 ton/hour to 6 ton/hour.

The invention further provides a device for preparing the nectar of malt soda, including
malt juice preparation device, for preparing the malt juice;
soda water preparation device, for preparing the soda water;
mixing and blending device, for mixing and formulating the malt juice and soda water;
sterilizing and filtrating device, for sterilizing and filtrating the mixed and formulated mixture solution of malt juice and soda water.

The invention further provides a nectar of malt soda, the preparation steps for the nectar of malt soda include: preparing malt juice, preparing soda water, formulating in formulating tank, sterilizing with ozone, sophisticated filtrating, pressing carbon dioxide therein, filing and seal-capping, quality inspection, spraying the code, encasement and putting in storage, wherein
(1) the preparing malt juice consists of the following steps and composition:
   selecting high quality and fresh malt, smashing the same to distribute each part of the malt uniformly, squeezing the smashed malt slightly, feeding into a cooking pot after the squeezing, cooking with a ratio of 100 kg malt to 900 kg water, the cooking temperature is controlled between 96° C. to 98 ° C., continuous stirring with a stirrer during the cooking, time for cooking the malt is 15 minutes to 18 minutes; protein is transferred to soluble malt extract after the malt and water was heated to boil in the cooking pot, and vitamins and mineral substance of the malt is remained; finally, the malt juice is obtained after preliminary filtration, sophisticated filtration and reverse osmosis filtration of the product obtained by the last step;
(2) the preparing soda water consists of the following steps and composition:
   soda water (sodium bicarbonate aqueous solution) is obtained after several steps such as mechanical filtration, activated carbon filtration, reverse osmosis filtration, formulated by adding sodium bicarbonate, ozone sterilization and the like; wherein dosage of sodium bicarbonate is 0.8 mg/L to 1.0mg/L (i.e. adding 0.8 mg to 1.0 mg sodium bicarbonate to each liter water), a disinfected soda water is obtained for the following step;
(3) the formulating in formulating tank consists of the following steps and composition:
   firstly adding 60% to 65% of the soda water to the formulating tank, secondly adding 35% to 40% of the malt juice to the formulating tank, then adding the additives according to the weight of the mixture solution in the formulating tank after fully stirring to homogeneous, the ratio of the mixture solution and the additives is:
   the mixture solution: 1000 kg
   Vitamin C: 0.5 kg to 0.6 kg
   calcium chloride: 0.05 kg to 0.08 kg
   aspartame: 0.02 kg to 0.03 kg
   erythritol: 10 kg to 12 kg liquid obtained from the last step is ozone-sterilized and sophisticated filtrated for use in the following steps;
(4) the pressing carbon dioxide therein, characterized in that:
   importing carbon dioxide gas to a carbonation tank under a pressure kept between 3.8 MPa to 4 MPa, the liquid obtain from step (3) is sprayed to a pressure cylinder in a flow rate of 5 T/h to 6 T/h, so as to generate carbonated water from the carbon dioxide and the liquid, then the nectar of malt soda of the invention is obtained.

The following technical effects can be obtained by the nectar of malt soda and method and device for preparing the same provided by the invention:
1. Liquid malt beverage can be prepared. The present invention prepares nectar of malt soda by mixing malt juice and soda water. During the preparation of nectar of malt soda, the malt is cooked, proteins in malt are transferred to soluble malt extract after the malt and water was heated to boil, and vitamins and mineral substance of the malt is remained. The soluble malt and soda water are combined together to form a liquid malt beverage and the nutrition and taste of the beverage are also ensured.
2. The process for preparing the malt beverage is improved. The steps for preparing malt juice of the invention include: smashing the malt; squeezing the smashed malt; cooking the squeezed malt; filtrating the cooked malt one or more times. By means of the process mentioned above, the nutrition constituents would not loss, furthermore, these nutrition constituents are transferred into substances that can be dissolved. After filtrated, these substances have higher purity and better quality.
3. The nectar of malt soda of the invention is nutrient-rich and has good taste. In the present invention malt juice and soda water is mixed and stirred, various additives such as vitamin C, and/or calcium chloride, and/or aspartame, and/or erythritol, and the like are added therein, and thereby the drink of nectar of malt soda has both the faint scent taste of malt and alkalescence health care function of soda water. In addition, the drink of the invention not only comprises vitamin C, Vitamin B, crude fiber, phospholipids, dextrin, maltose, glucose, trace elements and minerals and has health care functions such as balancing the body acidic and promoting digestion, but also has an advantage of easy to drink. On the other hand, certain carbon dioxide is pressed in the beverage during the preparation of the nectar of malt soda, so as to make carbonated beverage which is more suitable for industrial production.
4. The present invention uses malt and soda water (sodium bicarbonate aqueous solution) with health care function as the main raw materials, along with various additives, to prepare a novel carbonated beverage of malt soda by improved modern technology. The invention improves the process technology of traditional malt beverage and soda water beverage, remains the health care effects of malt and soda water, and overcomes the shortcomings of monotonous taste of soda water and that the malt juice is not easy to produce liquid beverage. In addition, the invention has technological innovations on aspects such as process, formulation, taste, health-care, industrial production and the like, and thus provides a mixed carbonated beverage which has both the faint scent taste of malt and alkalescence health care function of soda water, and is suitable for industrial production. It comprises vitamin C, Vitamin B, crude fiber, phospholipids, dextrin, maltose, glucose, trace elements and minerals and has health care functions such as balancing the body acidic and promoting digestion, but also has an advantage of faint scent taste and easy to drink.

### DESCRIPTION OF THE DRAWINGS

To illustrate the embodiments of the invention or the prior art more clearly, drawings used in the description for the embodiments of the invention or the prior art will be briefly described in the following. It is obvious that the drawings in the description below are only some exemplified examples of the invention, and those skilled in the art can obtain other examples and drawings thereof by the examples illustrated in the drawings herein without any inventive work.

FIG. 1 is a schematic diagram for the preparation method of the nectar of malt soda of the invention.

FIG. 2 is a preparation process flow diagram for a particular example of the nectar of malt soda of the invention.

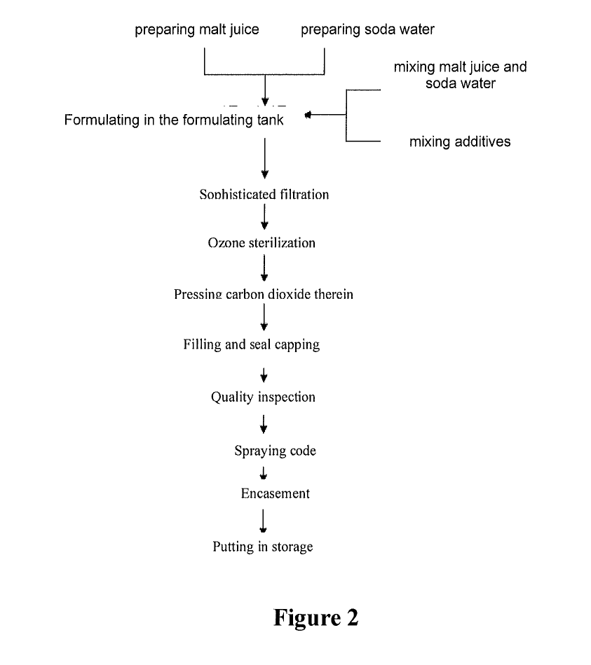

### DETAILED DESCRIPTION OF THE INVENTION

Hereinafter, technical solutions of various embodiments of the invention will be described clearly and completely with reference to the accompanying drawings. Obviously, the examples used herein are only part of, but not all of the examples of the invention. All the other examples obtained by those skilled in the art without involving any inventive work and based on the examples of the invention fall into the protection scope of the invention.

The invention provides a nectar of malt soda, comprising malt juice and soda water.

Preferably, the nectar of malt soda further comprises: vitamin C, and/or calcium chloride, and/or aspartame, and/or erythritol.

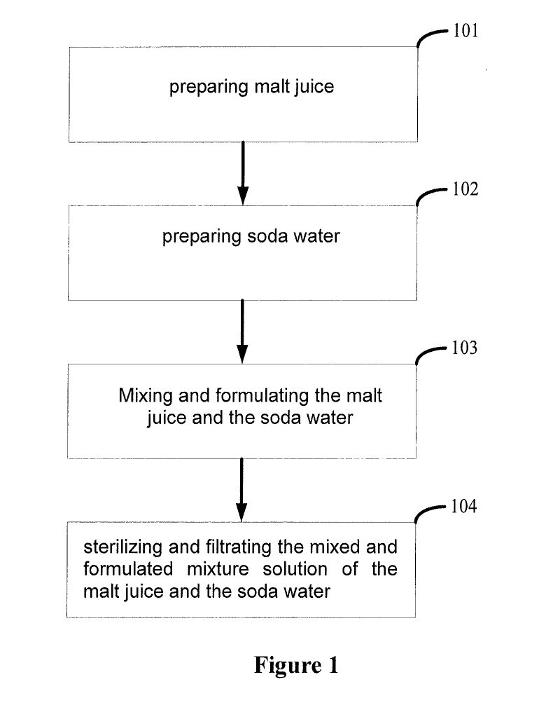

The invention further provides a method for preparing the nectar of malt soda, including:
preparing malt juice, see Step 101 in FIG. 1;
preparing soda water, see Step 102 in FIG. 1;
mixing and formulating the malt juice and the soda water, see Step 103 in FIG. 1;
sterilizing and filtrating the mixed and formulated mixture solution of the malt juice and the
soda water, see Step 104 in FIG. 1;
carbon dioxide may be pressed therein to prepare carbonated beverage after Step 104.

The invention further provides a device for preparing the nectar of malt soda, including:
malt juice preparation device, for preparing the malt juice;
soda water preparation device, for preparing the soda water;
mixing and blending device, for mixing and formulating the malt juice and soda water;
sterilizing and filtrating device, for sterilizing and filtrating the mixed and formulated mixture solution of malt juice and soda water;
packaging device, for packaging the sterilized and filtrated mixture solution of the malt juice and the soda water.

In Step 101 of preparing malt juice in FIG. 1:
the malt is smashed;
the smashed malt is squeezed;
the squeezed malt is cooked, preferably during the cooking the following conditions may be included simultaneously or respectively: the mass ratio of malt and water may be 1:7 to 1:10, such as 1:7, 1:8, 1:9 or 1:10, preferably 1:9; the temperature for the cooking may be 90° C. to 110° C., such as 90° C., 95° C., 96° C., 98° C., 100° C., 105° C., 110° C. or range between the temperatures above, preferable 96° C. to 98° C.; the malt is stirred continuously or intermittently during the cooking; cooking time may be 10 minutes to 20 minutes, such as 10 minutes, 15 minutes, 18 minutes, 20 minutes or ranges between the time above, preferable 15 minutes to 18 minutes;
the cooked malt is filtrated one or more times, and the filtration may include preliminary filtration, general filtration, sophisticated filtration, reverse osmosis filtration, or combinations of several filtration mentioned above.

In a preferable example, firstly, high quality and fresh malt was selected and put into the malt juice preparation device. In the smashing device of the malt juice preparation device, the malt was smashed to distribute each part of the malt uniformly. Secondly, in the squeezing device of the malt juice preparation device the smashed malt is squeezed, the level of the squeezing force depending on the actual situation and experience. After squeezed the malt is fed into a cooking device of the malt juice preparation device, preferable a cooking pot. The cooking is done with a ratio of 100 kg malt to 900 kg water, i.e. the ratio of malt to water is 1:9. The cooking temperature is controlled between 96° C. to 98 ° C. Stirring with a stirrer is continuous during the cooking, time for cooking the malt is 15 minutes to 18 minutes. Protein is transferred to soluble malt extract after the malt and water was heated to boil in the cooking pot, and vitamins and mineral substance of the malt is remained. Finally, the obtained malt juice was fed into the filtration device of the malt juice preparation device to be filtrated one or more times. The malt juice was obtained for the following steps after preliminary filtration, sophisticated filtration and reverse osmosis filtration.

The malt was cooked, and proteins in the malt were transferred to soluble malt extract after the malt and water were heated to boil.

Smashing the malt, squeezing the smashed malt, cooking the squeezed malt, and filtrating the cooked malt one or more times, by means of the processes the nutrition constituents would not loss, furthermore, these nutrition constituents are transferred into substances that can be dissolved. After filtrated, these substances have higher purity and better quality.

In the step of preparing soda water, see Step 102 in FIG. 1, including:
filtrating raw water one or more times, wherein the filtration may includes mechanical filtration, activated carbon filtration, reverse osmosis filtration or combination thereof;
adding sodium bicarbonate to the filtrated raw water;
sterilizing the raw water added sodium bicarbonate therein.

In an example, firstly, in the raw water filtration device of the soda water preparation device, raw water was mechanical filtrated, activated carbon filtrated, reverse osmosis filtrated; secondly, in the formulating device of the soda water preparation device, sodium bicarbonate was added therein to formulate the sodium bicarbonate and the raw water; thirdly, in the sterilizing device of the soda water preparation, the mixture solution of sodium bicarbonate and raw water was ozone sterilized, if required, further treatments may be executed to obtain the soda water (sodium bicarbonate aqueous solution), such as one or more steps of further filtration, further sterilization, split charging and the like. The amount of sodium bicarbonate is 0.5 mg/L to 1.2 mg/L, such as 0.5 mg/L, 0.6 mg/L, 0.7 mg/L, 0.8 mg/L, 0.9 mg/L, 1.0 mg/L, 1.1 mg/L, 1.2 mg/L or range between the values mentioned above, preferably is 0.8 mg/L to 1 mg/L (i.e. 0.8 mg to 1 mg sodium bicarbonate was added to each liter water. Sterilized soda water was obtained for the following steps.

Raw water mentioned in the invention directs to water derived from natural water body or stored water body, such as river, lake, pool or aquifer underground, as well as water used to be water supply source for preparing kinds of drink. The quality of raw water differs due to the water sources.

In the step of mixing and formulating the malt juice and the soda water, see Step 103 in FIG. 1:

For improving trophism, solubility of the malt juice and remaining vitamins and minerals of the malt itself, soluble malt extract is combined with soda water, thereby a liquid malt beverage is prepared. Meanwhile, nutrition and taste of the beverage are also ensured. 60% to 65% of soda water and 35% to 40% of malt juice are mixed and stirred.

After mixed malt juice and soda water, various additives may be added into the mixture solution to adjust the nutrition, taste, quality guarantee period and the like.

Additives are added to the homogeneous mixture solution of soda water and malt juice after stirred, preferably, the additives including vitamin C, and/or calcium chloride, and/or aspartame, and/or erythritol.

Preferably, the ratio of the additives is: in case of 1000 kg of soda water and malt juice mixture solution, the additives include 0.5 kg to 0.6 kg vitamin C, and/or 0.05 kg to 0.08 kg calcium chloride, and/or 0.02 kg to 0.03 kg aspartame, and/or 10 kg to 12 kg erythritol.

Therefore, the mixture solution of soda water and malt juice further includes: vitamin C, and/or calcium chloride, and/or aspartame, and/or erythritol. Thereby the drink of nectar of malt soda of the invention has both the faint scent taste of malt and alkalescence health care function of soda water. It comprises vitamin C, Vitamin B, crude fiber, phospholipids, dextrin, maltose, glucose, trace elements and minerals and has health care functions such as balancing the body acidic and promoting digestion, but also has an advantage of easy to drink.

In the step of sterilizing and filtrating the mixed and formulated mixture solution of the malt juice and the soda water, see Step 104 in FIG. 1:

To improve the quality guarantee period of the mixture solution of malt juice and soda water added with additives for healthy drinking, the solution still need to be sterilized and filtrated in the sterilizing and filtrating device. The sterilization preferably is ozone sterilization. The filtration preferably is sophisticated filtration or reverse osmosis filtration or combination of the two, to obtain preliminarily a non-carbonated nectar of malt soda.

A step is added after step 104 of FIG. 1: press carbon dioxide into the mixture solution of the sterilized and filtrated malt juice and soda water in the gas injection device.

In the present market, there are carbonated drink and non-carbonated drink. In a particular embodiment, to meet requirement of various customers, carbon dioxide may be pressed into the mixture solution of malt juice and soda water on the basis of the non-carbonated drink prepared with mixed solution of malt juice and soda water. That is, a step is added between step 104 and step 106 of FIG. 1: carbon dioxide is pressed into the sterilized and filtrated mixture solution of malt juice and soda water in the gas injection device. In the gas injection device, the pressure on the sterilized and filtrated mixture solution is remained at 3.5 MPa to 4.5 MPa, such as 3.5 MPa, 3.6 Mpa, 3.7 MPa, 3.8 Mpa, 3.9 Mpa, 4.0 Mpa, 4.1 Mpa, 4.2 Mpa, 4.3 Mpa, 4.4 Mpa, 4.5 Mpa or ranges between the values mentioned above, preferably, 3.8 Mpa to 4 Mpa. Carbon dioxide is spraied into the mixture solution of malt juice and soda water in the gas injection device with a flow rate of 4 ton/hour to 7 ton/hour, such as 4 ton/hour, 5 ton/hour, 6 ton/hour, 7 ton/hour, or ranges between the above values, preferably 5 ton/hour to 6 ton/hour, to obtain preliminarily the carbonated nectar malt soda.

After carbon dioxide pressed, a step is added for the sake of later packaging and sale: packaging the sterilized and filtrated mixture solution of malt juice and soda water, wherein:

After carbonated nectar of malt soda or non-carbonated nectar of malt soda is obtained preliminarily, preferably it is packaged in the packaging device. Preferably the packaging includes one or combination of more steps as the following:
filling and seal capping the carbonated nectar of malt soda or non-carbonated nectar of malt soda;
quality inspection;
spraying code;
encasement;
putting in storage.

For the above technology, the invention may also adopt the following examples according to the actual situation:

The preparation steps for the nectar of malt soda include: preparing malt juice, preparing soda water, formulating in a formulating tank, sterilizing with ozone, sophisticated filtrating, pressing carbon dioxide therein, filing and seal-capping, quality inspection, spraying the code, encasement and putting in storage.

### 1. Preparation of the Malt Juice.

High quality and fresh malt 100 kg is selected, the malt is smashed so as to distribute each part of the malt uniformly. The smashed malt is squeezed slightly, then fed into a cooking pot after the squeezing, and cooked after 900 kg water is added therein. The cooking temperature is controlled between 96° C. to 98° C. Continuous stirring is done with a stirrer during the cooking, and the time for cooking the malt is 15 minutes to 18 minutes. Protein is transferred to soluble malt extract after the malt and water was heated to boil in the cooking pot, and vitamins and mineral substance of the malt is remained. Finally, the malt juice of 930 kg to 950 kg is obtained after preliminary filtration, sophisticated filtration and reverse osmosis filtration of the product obtained by the last step.

### 2. Preparation of Soda Water.

soda water (sodium bicarbonate aqueous solution) is obtained after several steps such as mechanical filtration, activated carbon filtration, reverse osmosis filtration, formulated by adding 1 kg of sodium bicarbonate, ozone sterilization and the like. In the example, the ratio of sodium bicarbonate to water is 1:1000 (by weight), and 1000 kg of soda water is obtained for the following use.

### 3. Formulating in a Formulation Tank.

600 kg of soda water was fed into the formulating tank, then 400 kg of the malt juice is fed into the formulating tank and stirred completely to mix the malt juice and the soda water homogeneously. After stirred to homogeneous, the additives were added as the following:
Vitamin C: 0.5 kg
calcium chloride: 0.06 kg
aspartame: 0.03 kg
erythritol: 10 kg

The liquid obtained from the last step was ozone-sterilized and sophisticated filtrated for use in the following steps.

### 4. Pressing Carbon Dioxide Therein.

Carbon dioxide gas was imported to a carbonation tank under a pressure kept between 3.8 MPa to 4 MPa, the liquid obtain from step 3 is sprayed to a pressure cylinder with a flow rate of 5 T/h to 6 T/h, so as to generate carbonated water by the complete fusion of the carbon dioxide and the liquid, then the nectar of malt soda of the invention is obtained.

The product of nectar of malt soda of the invention is obtained after the nectar of malt soda mentioned above is filled, seal-capped, quality inspection, spraying the code, encasement and putting in storage. It comprises vitamin C, Vitamin B, crude fiber, phospholipids, dextrin, maltose, glucose, trace elements and minerals and has health care functions such as balancing the body acidic and promoting digestion, but also has advantages of faint scent taste and easy to drink.

The present invention used malt and soda water (sodium bicarbonate aqueous solution) with health care function as the main raw materials, along with various additives, and prepared a novel carbonated beverage of malt soda by improved modern technology. The invention improves the process technology of traditional malt beverage and soda water beverage, remains the health care effects of malt and soda water, and overcomes the shortcomings of monotonous taste of soda water and that the malt juice is not easy to produce liquid beverage. In addition, the invention has technological innovations on aspects such as process, formulation, taste, health-care, industrial production and the like, and thus provides a mixed carbonated beverage which has both the faint scent taste of malt and alkalescence health care function of soda water, and is suitable for industrial production. It comprises vitamin C, Vitamin B, crude fiber, phospholipids, dextrin, maltose, glucose, trace elements and minerals and has health care functions such as balancing the body acidic and promoting digestion, but also has advantages of faint scent taste and easy to drink.

The following technical effects can be obtained by the nectar of malt soda and method and device for preparing the same provided by the invention:
1. Liquid malt beverage can be prepared. The present invention prepares nectar of malt soda by mixing malt juice and soda water. During the preparation of nectar of malt soda, the malt is cooked, proteins in malt are transferred to soluble malt extract after the malt and water was heated to boil, and vitamins and mineral substance of the malt is remained. The soluble malt and soda water are combined together to form a liquid malt beverage and the nutrition and taste of the beverage are also ensured.
2. The process for preparing the malt beverage is improved. The steps for preparing malt juice of the invention include: smashing the malt; squeezing the smashed malt; cooking the squeezed malt; filtrating the cooked malt one or more times. By means of the process mentioned above, the nutrition constituents would not loss, furthermore, these nutrition constituents are transferred into substances that can be dissolved. After filtrated, these substances have higher purity and better quality.
3. The nectar of malt soda of the invention is nutrient-rich and has good taste. In the present invention malt juice and soda water is mixed and stirred, various additives such as vitamin C, and/or calcium chloride, and/or aspartame, and/or erythritol, and the like are added therein, and thereby the drink of nectar of malt soda has both the faint scent taste of malt and alkalescence health care function of soda water. In addition, the drink of the invention not only comprises vitamin C, Vitamin B, crude fiber, phospholipids, dextrin, maltose, glucose, trace elements and minerals and has health care functions such as balancing the body acidic and promoting digestion, but also has an advantage of easy to drink. On the other hand, certain carbon dioxide is pressed in the beverage during the preparation of the nectar of malt soda, so as to make carbonated beverage which is more suitable for industrial production.

The embodiments provided herein may be combined each other in any way according the requirements. Those technical solution obtained by such combination also fall into the scope of the invention.

It is obvious that those skilled in the art may vary and modify the invention without depart from the spirit and scope of the invention. Therefore, if the modifications and variations fall into the scope of the claims and equivalents thereof, the invention also covers these modifications and variations.

1. A nectar of malt soda, comprising malt juice and soda water.

2. The nectar of malt soda according to claim 1, further comprising vitamin C, and/or calcium chloride, and/or aspartame, and/or erythritol.

3. A method for preparing the nectar of malt soda according to claim 1, including:
preparing malt juice;
preparing soda water;
mixing and formulating the malt juice and the soda water;
sterilizing and filtrating the mixed and formulated mixture solution of the malt juice and the soda water.

4. The method for preparing the nectar of malt soda according to claim 3, wherein, the step of preparing malt juice including:
Smashing the malt;
Squeezing the smashed malt;
cooking the squeezed malt; and
filtrating the cooked malt for one or more times.

5. The method for preparing the nectar of malt soda according to claim 4, wherein the mass ratio of malt to water is 1:9 in the cooking the squeezed malt;
and/or
a temperature for the cooking is from 96° C. to 98° C. in the cooking the squeezed malt;
and/or
the cooking the squeezed malt includes stirring the malt during the cooking;
and/or
time for the cooking is from 15 minutes to 18 minutes in the cooking the squeezed malt.

6. The method for preparing the nectar of malt soda according to claim 3, wherein the preparing soda water includes:
filtrating raw water for one or more times;
adding sodium bicarbonate to the filtrated raw water;
sterilizing the raw water added sodium bicarbonate.

7. The method for preparing the nectar of malt soda according to claim 6, wherein
the adding sodium bicarbonate to the filtrated raw water includes: adding 0.8 mg to 1 mg of sodium bicarbonate to each IL water.

8. The method for preparing the nectar of malt soda according to claim 3, wherein
the mixing and formulating the malt juice and the soda water includes:
mixing and stirring 60%-65% of soda water and 35%-40% malt juice;
the mixing and formulating the malt juice and the soda water further includes:
adding additives to the homogeneous mixture solution of soda water and malt juice after stirred, the additives including vitamin C, and/or calcium chloride, and/or aspartame, and/or erythritol;
the mixture solution of soda water and malt juice further includes: vitamin C, and/or calcium chloride, and/or aspartame, and/or erythritol.

9. The method for preparing the nectar of malt soda according to claim 8, wherein the amount of the additives is:
in case of 1000 kg of soda water and malt juice mixture solution, the additives include 0.5 kg to 0.6kg vitamin C, and/or 0.05 kg to 0.08 kg calcium chloride, and/or 0.02 kg to 0.03 kg aspartame, and/or 10 kg to 12 kg erythritol.

10. The method for preparing the nectar of malt soda according to anyone of claims 3, wherein
after sterilizing and filtrating the mixed and formulated mixture solution of soda water and malt juice, the method further includes:
pressing carbon dioxide to the sterilized and filtrated mixture solution, wherein the pressure on the sterilized and filtrated mixture solution is 3.8 MPa to 4 MPa, flow rate of the carbon dioxide is 5 ton/hour to 6 ton/hour.

11. A device for preparing the nectar of malt soda according to claim 1, the device includes:
malt juice preparation device, for preparing the malt juice;
soda water preparation device, for preparing the soda water;
mixing and blending device, for mixing and formulating the malt juice and soda water;
sterilizing and filtrating device, for sterilizing and filtrating the mixed and formulated mixture solution of malt juice and soda water.

12. A nectar of malt soda, the preparation steps for the nectar of malt soda include: preparing malt juice, preparing soda water, formulating in formulating tank, sterilizing with ozone, sophisticated filtrating, pressing carbon dioxide therein, filing and seal-capping, quality inspection, spraying the code, encasement and putting in storage, wherein
(1) the preparing malt juice consists of the following steps and composition:
selecting high quality and fresh malt, smashing the same to distribute each part of the malt uniformly, squeezing the smashed malt slightly, feeding into a cooking pot after the squeezing, cooking with a ratio of 100 kg malt to 900 kg water, the cooking temperature is controlled between 96° C. to 98° C., continuous stirring with a stirrer during the cooking, time for cooking the malt is 15 minutes to 18 minutes; protein is transferred to soluble malt extract after the malt and water was heated to boil in the cooking pot, and vitamins and mineral substance of the malt is remained; finally, the malt juice is obtained after preliminary filtration, sophisticated filtration and reverse osmosis filtration of the product obtained by the last step;
(2) the preparing soda water consists of the following steps and composition:
soda water (sodium bicarbonate aqueous solution) is obtained after several steps such as mechanical filtration, activated carbon filtration, reverse osmosis filtration, formulated by adding sodium bicarbonate, ozone sterilization and the like; wherein dosage of sodium bicarbonate is 0.8 mg/L to 1.0mg/L (i.e. adding 0.8 mg to 1.0 mg sodium bicarbonate to each liter water), a disinfected soda water is obtained for the following step;
(3) the formulating in formulating tank consists of the following steps and composition:
firstly adding 60% to 65% of the soda water to the formulating tank, secondly adding 35% to 40% of the malt juice to the formulating tank, then adding the additives according to the weight of the mixture solution into the formulating tank after fully stirring to homogeneous, the ratio of the mixture solution and the additives is:
the mixture solution: 1000 kg
Vitamin C: 0.5 kg to 0.6 kg
calcium chloride: 0.05 kg to 0.08 kg
aspartame: 0.02 kg to 0.03 kg
erythritol: 10 kg to 12 kg
liquid obtained from the last step is ozone-sterilized and sophisticated filtrated for use in the following steps;
(4) the pressing carbon dioxide therein, characterized in that:
importing carbon dioxide gas to a carbonation tank under a pressure kept between 3.8 MPa to 4 MPa, the liquid obtain from step (3) is sprayed to a pressure cylinder in a flow rate of 5 T/h to 6 T/h, so as to generate carbonated water from the carbon dioxide and the liquid, then the nectar of malt soda of the invention is obtained.

13. The method for preparing the nectar of malt soda according to claim 4, wherein
after sterilizing and filtrating the mixed and formulated mixture solution of soda water and malt juice, the method further includes:
pressing carbon dioxide to the sterilized and filtrated mixture solution, wherein the pressure on the sterilized and filtrated mixture solution is 3.8 MPa to 4 MPa, flow rate of the carbon dioxide is 5 ton/hour to 6 ton/hour.

14. The method for preparing the nectar of malt soda according to claim 5, wherein
after sterilizing and filtrating the mixed and formulated mixture solution of soda water and malt juice, the method further includes:
pressing carbon dioxide to the sterilized and filtrated mixture solution, wherein the pressure on the sterilized and filtrated mixture solution is 3.8 MPa to 4 MPa, flow rate of the carbon dioxide is 5 ton/hour to 6 ton/hour.

15. The method for preparing the nectar of malt soda according to claim 6, wherein
after sterilizing and filtrating the mixed and formulated mixture solution of soda water and malt juice, the method further includes:
pressing carbon dioxide to the sterilized and filtrated mixture solution, wherein the pressure on the sterilized and filtrated mixture solution is 3.8 MPa to 4 MPa, flow rate of the carbon dioxide is 5 ton/hour to 6 ton/hour.

16. The method for preparing the nectar of malt soda according to claim 7, wherein
after sterilizing and filtrating the mixed and formulated mixture solution of soda water and malt juice, the method further includes:
pressing carbon dioxide to the sterilized and filtrated mixture solution, wherein the pressure on the sterilized and filtrated mixture solution is 3.8 MPa to 4 MPa, flow rate of the carbon dioxide is 5 ton/hour to 6 ton/hour.

17. The method for preparing the nectar of malt soda according to claim 8, wherein
after sterilizing and filtrating the mixed and formulated mixture solution of soda water and malt juice, the method further includes:
pressing carbon dioxide to the sterilized and filtrated mixture solution, wherein the pressure on the sterilized and filtrated mixture solution is 3.8 MPa to 4 MPa, flow rate of the carbon dioxide is 5 ton/hour to 6 ton/hour.

18. The method for preparing the nectar of malt soda according to claim 9, wherein
after sterilizing and filtrating the mixed and formulated mixture solution of soda water and malt juice, the method further includes:
pressing carbon dioxide to the sterilized and filtrated mixture solution, wherein the pressure on the sterilized and filtrated mixture solution is 3.8 MPa to 4 MPa, flow rate of the carbon dioxide is 5 ton/hour to 6 ton/hour.

19. A device for preparing the nectar of malt soda according to claim 1, the device includes:
malt juice preparation device, for preparing the malt juice;
soda water preparation device, for preparing the soda water;
mixing and blending device, for mixing and formulating the malt juice and soda water;
sterilizing and filtrating device, for sterilizing and filtrating the mixed and formulated mixture solution of malt juice and soda water.
